(19) United States
(12) Patent Application Publication
(10) Pub. No.: US 2026/0114387 A1
(43) Pub. Date: Apr. 30, 2026

(54) SINGLE STAGE MUSHROOM SUBSTRATE MIXER

(71) Applicant: F2F, Inc. DBA Forest to Fork, Faribault, MN (US)

(72) Inventor: Dana Anderson, Minneapolis, MN (US)

(73) Assignee: F2F, Inc. DBA Forest to Fork, Faribault, MN (US)

(21) Appl. No.: 18/943,373

(22) Filed: Nov. 11, 2024

Related U.S. Application Data
(63) Continuation of application No. PCT/US2023/024308, filed on Jun. 2, 2023.
(60) Provisional application No. 63/348,822, filed on Jun. 3, 2022.

(51) Int. Cl. A01G 18/22; A01G 18/30; A01G 18/50

(52) U.S. Cl. CPC A01G 18/22; A01G 18/30; A01G 18/50

(57) ABSTRACT

Example mixers and methods for using mixers for cultivating mushrooms are disclosed. An example single stage mixer for cultivating mushrooms includes a mixing container defining an internal mixing chamber, a lid coupled to the mixing container, the lid configured to shift between a sealed configuration and an open configuration. The mixing container also includes a rotatable agitator coupled to the mixing container, a water supply member positioned within the internal mixing chamber and a heating element attached to the mixing container.

### CROSS REFERENCE TO RELATED APPLICATIONS

This application is a continuation of International Application No. PCT/US2023/024308, filed Jun. 2, 2023, which claims the benefit of U.S. Provisional Patent Application Ser. No. 63/348,822 filed on Jun. 3, 2022, the disclosure of which are incorporated herein by reference.

### TECHNICAL FIELD

The present disclosure relates to methods and apparatus for sterile batch preparation, inoculation, and bagging of mushroom substrate.

### BACKGROUND

Conventional methods for preparing mushroom substrate may include several steps requiring multiple pieces of equipment. These steps may include substrate mixing, substrate sterilization, spawn preparation, substrate bagging, substrate inoculation, sealing the bags of inoculated substrate, colonizing, pinning, fruiting, and harvesting. Further, the equipment required to perform these steps may include a mixer, bed forming or bag filling equipment, a steam sterilizer and a clean room for inoculation.

Beginning with the preparation of the mushroom substrate, the methods used to cultivate mushrooms may aim to generate favorable growing conditions for the substrate while eliminating or substantially reducing adverse conditions (e.g., the presence of unwanted mildew, bacteria, detrimental microorganisms, etc.), such that the inoculation, growth and eventual mushroom harvesting may produce an optimal size and quantity of mushroom crop.

Mushroom substrate may include organic material that the mushrooms use as their energy source for growth. Different species of mushrooms may grow more effectively in different substrates. It can be appreciated that the mushroom substrate utilized to grow a particular type of mushroom species may significantly impact both the size and quantity of the mushroom crop. Accordingly, a variety of materials may be combined to produce a mushroom substrate for a particular type of mushroom. For example, shiitake mushroom substrate may be formed from the combination of sawdust, soy hulls, barley, straw, or other organic materials. Additionally, adjustments may be made to substrate ratios to achieve the desired result for each particular mushroom species. This may include modifications to nitrogen and protein levels of the substrate.

In a conventional commercial operation, the individual materials selected to form a mushroom substrate may first be combined in a mushroom mixer designed to effectively and thoroughly mix the individual ingredients together. Next, the mushroom substrate may be placed in a bag and water may be added to a desired hydration level. Traditionally, water may be added to approach a 60% moisture level. The mushroom substrate may then be transferred to another machine to be sterilized. In some examples, sterilization of the substrate may be performed via the introduction of pressure and heat (via steam or other method of heating the substrate) in a machine (e.g., an autoclave) separate from the mixer. Further, after sterilization, the substrate must cool in the air to a temperature sufficient for inoculation (typically below 30 degrees Celsius). In traditional commercial settings, large amounts of biomass can take up to twenty-four hours to cool to acceptable levels to be inoculated.

After each individual bag of mushroom substrate is sterilized and includes the desired level of hydration, an inoculation step may be performed in which spawn, agar, or liquid culture is added to each individual bag of sterilized substrate. It can be appreciated that having to add spawn, agar, or liquid culture to each individual bag of substrate is inefficient and cost prohibitive.

After inoculation, the spawn incubates through the substrate. Incubation starts with leap off, which is the moment when the mycelium initially leaps off the spawn onto the new substrate. This occurs approximately four days after inoculation. The mycelium expands through the substrate in three-dimensions.

The rate at which a spawn run occurs may vary by species of mushroom. Oyster mushrooms, for instance, are faster growing than shiitake mushrooms. During incubation, temperature and humidity control are the two primary factors to maintain. In contrast, CO₂ and lighting conditions are not as important during this phase as in the fruiting phase.

As discussed above, in conventional mushroom farming operations, the steps of mixing the raw substrate material, bagging the substrate, hydrating the substrate, sterilizing the substrate (which may include pasteurization), inoculating the substrate, and sealing the bags of inoculated substrate may require several different machines, each performing an individual function. It can be appreciated that cultivating mushrooms using multiple machines may be inefficient, resulting in excess costs in time, money and resources. Accordingly, a need exists for a single stage mushroom mixer capable of performing multiple processes of the mushroom cultivation process within a single machine.

### BRIEF SUMMARY

This disclosure provides design, material, manufacturing methods for cultivating mushrooms. An example single stage mixer for cultivating mushrooms includes a mixing container defining an internal mixing chamber, a lid coupled to the mixing container, the lid configured to shift between a sealed configuration and an open configuration. The mixing container also includes a rotatable agitator coupled to the mixing container, a water supply member positioned within the internal mixing chamber and a heating element attached to the mixing container.

Alternatively or additionally to any of the embodiments above, wherein the water supply member includes a vertical water pipe positioned within the internal mixing chamber.

Alternatively or additionally to any of the embodiments above, wherein the water pipe includes a first end attached to an inner surface of the mixing container, and a second end which is open to the internal mixing chamber of the mixing container.

Alternatively or additionally to any of the embodiments above, wherein the water pipe is configured to permit water to overflow out the second end and into the mixing chamber.

Alternatively or additionally to any of the embodiments above, wherein the heating element is positioned within the water pipe.

Alternatively or additionally to any of the embodiments above, wherein the agitator includes a ribbon agitator.

Alternatively or additionally to any of the embodiments above, wherein the ribbon agitator extends circumferentially around the vertical water pipe.

Alternatively or additionally to any of the embodiments above, wherein the heating element is configured to heat water in the water pipe to create a water vapor within the mixing chamber, and wherein the water vapor is configured to increase pressure within the mixing chamber.

Alternatively or additionally to any of the embodiments above, wherein the increase in pressure within the mixing chamber can heat a mushroom substrate to a temperature and a pressure sufficient to sterilize the mushroom substrate.

Alternatively or additionally to any of the embodiments above, further comprising an inoculation port positioned on the mixing container, wherein the inoculation port defines an access pathway into the mixing chamber.

Alternatively or additionally to any of the embodiments above, further comprising an air filter hood assembly positioned adjacent to the inoculation port.

Alternatively or additionally to any of the embodiments above, wherein the air filter hood assembly includes a HEPA filter.

Alternatively or additionally to any of the embodiments above, wherein the air filter hood assembly includes a positive pressure fan.

Alternatively or additionally to any of the embodiments above, wherein the air filter hood assembly is positioned above the inoculation port.

Alternatively or additionally to any of the embodiments above, wherein the air filter hood assembly substantially surrounds the inoculation port.

Alternatively or additionally to any of the embodiments above, wherein the water supply member includes one or more water supply lines positioned within the internal mixing chamber.

Alternatively or additionally to any of the embodiments above, wherein the heating element includes a boiler attached to the mixing container.

Alternatively or additionally to any of the embodiments above, wherein the heating element includes a gas burner attached to the mixing container.

Alternatively or additionally to any of the embodiments above, wherein the heating element includes both a gas burner and a boiler attached to mixing container.

Alternatively or additionally to any of the embodiments above, further comprising a steam delivery tube coupled to both the boiler and the mixing container, and wherein the steam delivery tube is configured to transport steam from the boiler into the mixing container.

Alternatively or additionally to any of the embodiments above, wherein the boiler is configured to heat the steam when the lid is in the sealed configuration, and wherein the lid is configured to seal against the mixing container such that the boiler can heat a mushroom substrate to a temperature and a pressure sufficient to sterilize the mushroom substrate.

Alternatively or additionally to any of the embodiments above, further comprising an input chute having a first end region and a second end region, the first end region coupled to the mixing container and the second end region including a hatch configured to shift between a closed configuration and an open configuration.

Alternatively or additionally to any of the embodiments above, further comprising an air filter operatively coupled to a portion of the input chute.

Alternatively or additionally to any of the embodiments above, wherein the air filter includes a HEPA filter, and wherein the HEPA filter is configured to filter air blown into the mixing container.

Alternatively or additionally to any of the embodiments above, wherein the water supply member is in fluid communication with the mixing container, and wherein the water supply member is configured to transport reserve osmosis water, ozone water or both reverse osmosis water and ozone water into the mixing container.

Alternatively or additionally to any of the embodiments above, wherein the reverse osmosis water is configured to cool the mushroom substrate, and wherein the ozone water is configured to heat the mushroom substrate.

Alternatively or additionally to any of the embodiments above, further comprising a walking platform fixedly coupled to the base.

Alternatively or additionally to any of the embodiments above, further comprising a discharge chute, and wherein the discharge chute includes an auger.

Alternatively or additionally to any of the embodiments above, further comprising a discharge chute assembly, the discharge assembly including an upper discharge chute and a lower discharge chute, and wherein the lower discharge chute is configured to extend from a first length to a second length.

Alternatively or additionally to any of the embodiments above, wherein the lower discharge chute includes an inner cylinder coaxially arranged within an outer cylinder, and wherein the inner cylinder is configured to telescope relative to the outer cylinder.

Alternatively or additionally to any of the embodiments above, wherein the upper discharge chute is configured to laterally translate between a first position and a second position, and wherein the upper discharge chute is aligned with an aperture in the base member in the first position, wherein the upper discharge chute is spaced away from the aperture in the second position.

Alternatively or additionally to any of the embodiments above, where the lower discharge chute remains stationary as the upper discharge chute translates between the first position and the second position.

Alternatively or additionally to any of the embodiments above, wherein the lower discharge chute is configured to accept a packaging bag positioned along an outer surface of the lower discharge chute.

An example single stage mixer for cultivating mushrooms includes a mixing container defining an internal mixing chamber, a manway coupled to the mixing container, an inoculation port coupled to the mixing container, a ribbon agitator coupled to the mixing container and a water delivery member coupled to the mixing container.

Alternatively or additionally to any of the embodiments above, further comprising a heating element positioned within the internal mixing chamber of the mixing container.

An example method for cultivating mushrooms includes loading a substrate into a single-stage mixer through a first port, pressurizing the mixer to a pressure sufficient to sterilize the substrate, loading grain spawn into the single-stage mixer through a second port and mixing the grain spawn with the substrate to achieve a ratio of substrate to spawn of at most twenty parts substrate to one part spawn.

An example method for cultivating mushrooms includes loading substrate into a single-stage mixer. The mixer includes a mixing container, a shredder coupled to the mixing container and a discharge chute coupled to the base member. The method further includes passing a spawn block through the shredder and into the mixing container, mixing the shredded spawn with the substrate, discharging the substrate into a bag and sealing the bag.

Another method for cultivating mushrooms includes loading substrate into a single-stage mixer. The mixer includes a mixing container, a ribbon agitator coupled to the mixing container, an inoculation port, a water delivery member in fluid communication with the mixing container, a discharge chute coupled to the mixing container and a heating element coupled to the mixing container. The method further includes loading grain spawn into the single-stage mixer through the inoculation port, turning the ribbon agitator to mix the grain spawn with the substrate, discharging the substrate into a bag and sealing the bag.

Alternatively or additionally to any of the embodiments above, wherein the water delivery member includes a water pipe, and wherein the heating element is positioned within at least a portion of the water pipe.

Alternatively or additionally to any of the embodiments above, wherein the ribbon agitator circumferentially surrounds the water pipe.

The above summary of some embodiments is not intended to describe each disclosed embodiment or every implementation of the present disclosure. The Figures and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 illustrates a perspective view of an example mixer;

FIG. 2 illustrates another perspective view of the mixer shown in FIG. 1;

FIG. 3 illustrates a portion of the mixer shown in FIG. 1;

FIG. 4 illustrates a partial exploded view of the mixer shown in FIG. 3;

FIG. 5 illustrates a portion of the mixer shown in FIG. 1;

FIG. 6 illustrates a portion of the mixer shown in FIG. 1;

FIG. 7 illustrates a portion of the mixer shown in FIG. 1;

FIG. 8 illustrates another example mixer;

FIG. 9 illustrates another example mixer;

FIG. 10 illustrates another example mixer;

FIG. 11 illustrates an example wire rack;

FIG. 12 illustrates a perspective view of another example mixer;

FIG. 13 illustrates another perspective view of the mixer shown in FIG. 1;

FIG. 14 illustrates another example mixer.

### DETAILED DESCRIPTION

The following description should be read with reference to the drawings wherein like reference numerals indicate like elements throughout the several views. The detailed description and drawings illustrate example embodiments of the claimed disclosure.

It should be understood that this disclosure is, in many respects, only illustrative. Changes may be made in details, particularly in matters of shape, size, and arrangement of steps without exceeding the scope of the disclosure. The disclosure's scope is, of course, defined in the language in which the appended claims are expressed.

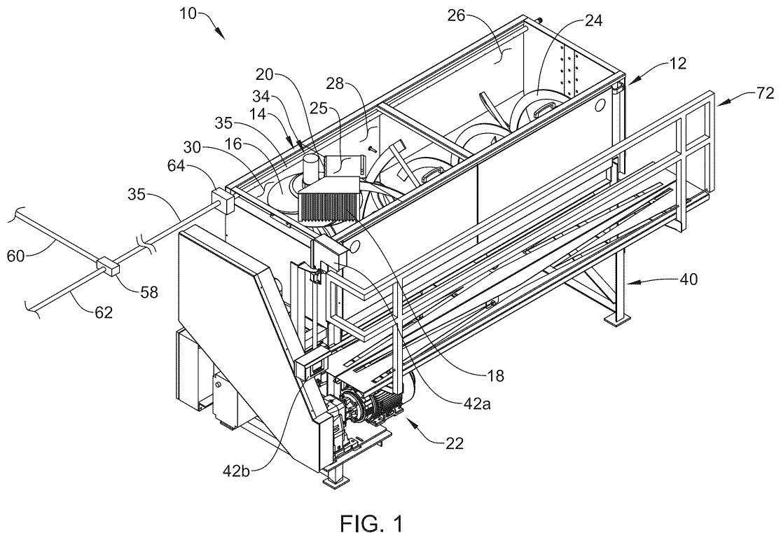

FIG. 1 illustrates a perspective view of an example single stage mixer 10. The single-stage mixer 10 may be utilized to streamline the production process of preparing mushroom substrate. For example, a batch inoculation process using the single-stage mixer 10 is disclosed herein. The batch inoculation methodology described herein eliminates the need for a clean room, autoclave (as a separate piece of production equipment) and inoculation equipment (e.g., petri dishes or syringes). Further, methods described herein may utilize a larger ratio of spawn-to-substrate as compared to traditional processes. For example, a typical spawn-to-substrate ratio may add sixty-parts substrate to every one-part spawn. Batch inoculation methods described herein, however, may add twenty-parts substrate to one-part spawn, for example. Achieving larger ratios of spawn-to-substrate during batch inoculation are difficult using traditional methods.

As disclosed herein, the mixer 10 may be utilized as a standalone, single stage mushroom mixer capable of performing multiple steps of a batch mushroom substrate cultivation process. For example, the mixer 10 may be utilized to combine (e.g., mix) raw material ingredients to form a mushroom substrate, sterilize the substrate, hydrate the substrate, prepare and introduce spawn into the substrate (e.g., inoculation of the substrate) and bag the inoculated substrate. In other words, the single stage mixer 10 may be designed to perform batch inoculation of mushroom substrate. Because the substrate is inoculated in the mixer 10 at higher ratios of spawn-to-substrate, the mycelium has a shorter distance to grow to attain a fully colonized bag ready for fruiting. When the mycelium runs into another leap-off point, the mycelium fuse together until the entire substrate becomes one mycelial organism. After the mycelium has grown throughout all the available food, full colonization is achieved and the mushrooms can be initiated into fruiting.

Further, in contrast to traditional mushroom cultivation processes that require a clean room for portions of the cultivation process, the mixer 10 may be designed to maintain its own sterile environment, thereby maintaining the sterility of the substrate while the steps of the mushroom cultivation process are performed.

As illustrated in FIG. 1, the mixer 10 may include a base 12 (e.g., a mixing container, chamber, tank, etc.) attached to a rigid framework 40. The base 12 may be constructed from one or more side panels and a floor. It can be appreciated that for examples in which the base 12 is formed from a plurality of panels, each of the side panels and the floor may be fixedly attached (e.g., interconnected) to one another to form the structure illustrated in FIG. 1. For example, the base may include 2, 3, 4, 5, 6, 7, 8 or more panels which are attached to one another to form of the sidewalls of the base 12. Yet, in other examples, the sidewalls of the base 12 may be formed from a single, monolithic sheet of material, whereby the monolithic sheet of material is folded and attached to itself to form a rectangular sidewall structure.

As discussed above, the base 12 may include a floor, whereby the floor is formed from one or more panels. The floor may be attached to the one or more panels defining the sidewalls (described above) to form a structure designed to hold the materials utilized to manufacture mushroom substrate. In some instances, the base 12 (including the sidewalls and the floor) may be designed to have a length of about 10 feet to 14 feet, width of about 2 feet to about 6 feet and a depth of about 3 feet to about 6 feet. In some examples, the base 12 may include a volume of about 25 cubic feet to about 525 cubic feet, or about 1 cubic yard to about 20 cubic yards. Further, a plurality of machines (e.g., plurality of mixers 10) may be coupled together to increase the capacity of the operation.

As will be discussed in greater detail below, the floor of the base 12 may be shaped to permit material contained in the base 12 to funnel to a central region of the floor, whereby the substrate material may pass through an aperture formed in the floor. In some examples, the floor may include one or more panels which are angled in a sloped configuration, thereby allowing material to slide down the side panels and the floor toward a central aperture in the floor. In other examples, the floor may be formed from a single, monolithic panel (e.g., monolithic sheet of material). In some examples, the floor may be substantially U-shaped. In other words, the floor may resemble a U-shaped trough having an aperture in a central region thereof. It can be appreciated that all of the combined sidewall and floor configurations disclosed herein may be designed to permit the mass of the substrate being held within the base 12 to funnel toward an aperture (e.g., a central aperture) positioned in the floor of the base 12. Further, in some alternative examples, the mixer 10 may include an aperture located in an end region of the floor of the base 12. In other words, it can be appreciated that, in some examples, the mixer 10 may include an aperture which is positioned along an end region of the floor of the base 12. In yet other examples, the mixer 12 may include more than one aperture positioned in the floor of the base 12.

In some examples, the mixer 10 may include one or more structures which form a heat shield around the panels defining the sides and the floor of the base 12. For example, the mixer 10 may include an outer layer of material designed to act as a heat shield around the base 12. For example, the mixer 10 may include a second layer of one or more panel that surround the sidewall panels, whereby the second layer of panels act as a heat shield for the sidewall panels. Similarly, the mixer 10 may include one or more panels (or a single sheet of material) attached on the outer surface of the floor of the base 12, whereby the additional flooring panel layer acts as a heat shield for the floor.

FIG. 1 further illustrates that the mixer 10 may include a first lid 26, a second lid 28 and a third lid 30 positioned along an upper surface of the sidewalls of the base 12. Each of the first lid 26, the second lid 28 and the third lid 30 may shaped such that each of the first lid 26, the second lid 28 and the third lid 30 may form an airtight seal along the upper surface of the sidewalls of the base 12. For examples, each of the first lid 26, the second lid 28 and the third lid 30 may include a square, rectangular or other shape that mates with the shape (e.g., dimensions) defined by the upper surface of the sidewalls of the base 12.

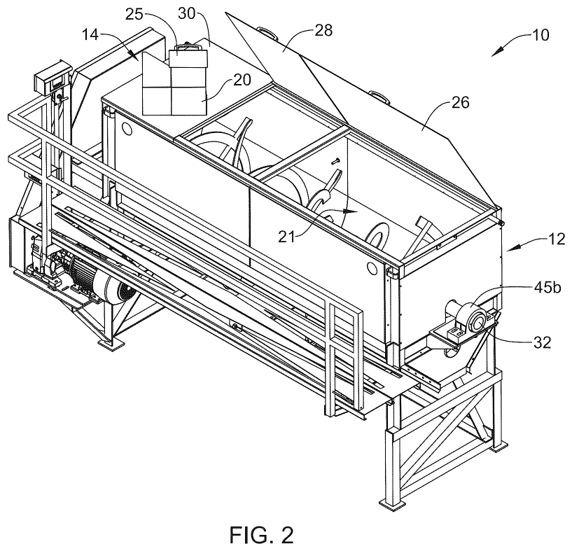

Referring to FIG. 2, each of the first lid 26, the second lid 28 and the third lid 30 may be attached to the sidewall via a hinge, whereby the hinged attachment of each of the first lid 26, the second lid 28 and the third lid 30 may allow each of the first lid 26, the second lid 28 and the third lid 30 to be opened while still maintaining the hinged attachment to the base 12. Additionally, as illustrated in FIG. 2, each of the first lid 26, the second lid 28 and the third lid 30, respectively, may include a handle designed to permit an operator to lift a respective lid, thereby allowing the operator access into the mixing chamber 21. It can be appreciated that an operator may place the organic material, nutrients, etc. used to make the mushroom substrate into the mixing chamber 21 via the openings defined by one or more of the first lid 26, the second lid 28 and/or the third lid 30.

Additionally, one or more of the first lid 26, the second lid 28 and/or the third lid 30 may be constructed of a transparent material. For example, one or more of the first lid 26, the second lid 28 and/or the third lid 30 may be formed from glass, plexiglass or the like. Constructing the first lid 26, the second lid 28 and/or the third lid 30 from a transparent material may allow an operator to easily visible the mixing of the materials place in the mixing chamber 21.

As discussed herein, each of the first lid 26, the second lid 28 and/or the third lid 30 may include one or more features which permit each of the first lid 26, the second lid 28 and/or the third lid 30 to form an airtight seal along the upper surface of the sidewalls. It can be appreciated, however, that in some examples, the lid 30 may be a replaced with a simple hood that does not open. This feature is important as the sealing of the lids permits the mixing chamber 21 to be pressurized in addition to being heated and/or cooled to desired temperatures. In some instances, the ability of the mixing chamber 21 to maintain an elevated pressure and/or temperature may permit the mixer 10 to operate as an autoclave. For example, as will be described in greater detail below, the mixer 10 may include one or more components (e.g., boiler) designed to inject steam and/or gas (e.g. ozone), into the mixing chamber 21. When operating as an autoclave, the mixer 10 may utilize the steam to elevate the temperature and pressure of the sealed mixing chamber 21. When operating as an autoclave, the mixer 10 may subject the material within the mixing chamber 21 to an elevated temperature and pressure (for a given length of time) in relation to ambient pressure and/or temperature. Subjecting the material in the mixing chamber 21 to elevated temperature and pressure for a given time period may sterilize the material, thereby eliminating the risk of undesirable mildews, bacteria, fungus, microorganisms, etc. from adversely affecting the eventual inoculation of the mushroom substrate.

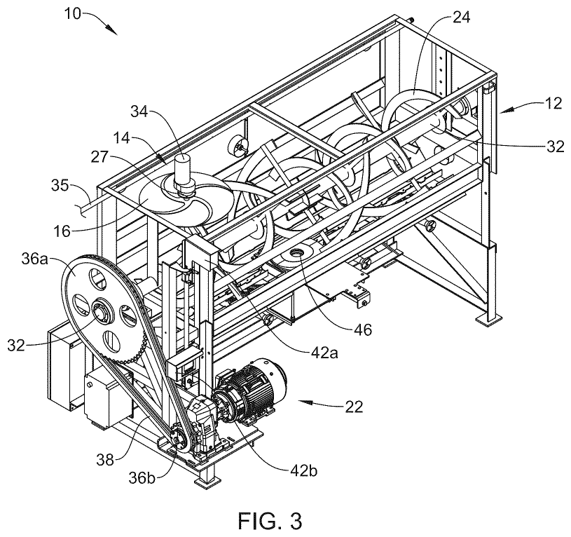

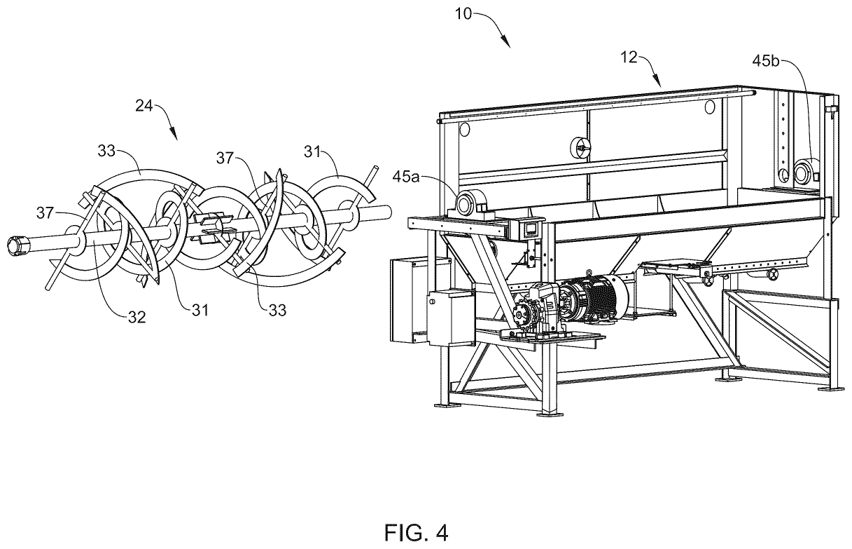

Referring back to FIG. 1, the mixer 10 may further include a ribbon agitator 24 positioned within the mixing chamber 21 of the mixer 10. The ribbon agitator 24 may be positioned in the U-shaped trough defined below the lid 30 with the agitator 24 spaced equidistant from the two sidewalls of the base 12. A shaft 32 (shown in FIGS. 3-4), supported on bearings 45a, 45b (both bearings 45a and 45b are shown in FIG. 4), may extend through the center of the base 12. Further, the shaft 32 may be driven by a motor 22. The ribbon agitator 24, shaft 32 and drive motor 22 will be described in greater detail below with respect to FIGS. 3-5.

FIG. 1 illustrates that the mixer 10 may further include a shredder assembly 14. The shredder assembly 14 may include a drive motor 34 coupled to a shredder blade 16. The drive motor 34 may be designed to provide power to spin the shredder blade 16. It can be appreciated from FIG. 1 that the shredder blade 16 may be positioned within the mixing chamber 21 while the drive motor 34 may be positioned outside of the mixing chamber 21. Accordingly, a drive shaft 27 (shown in FIG. 3) may extend through the lid 30, whereby the drive shaft may couple the drive motor 34 to the shredder blade 16. The lid 30 may be designed to seal around the drive shaft 27 extending therethrough, thereby assuring that the lid 30 can maintain an airtight seal between the drive shaft 27 and the base 12, as described above.

The shredder assembly 14 may further include an input chute 20 (e.g., chimney) vertically aligned over a portion of the shredder blade 16. A lid 25 may be positioned atop the input chute 20. Similarly to the lids 26, 28, 30 described herein, the lid 25 may be attached to the input chute 20 via a hinge positioned along a single upper edge of the input chute 20. The hinged connection of the lid 25 may permit an operator to open the lid 25, thereby permitting material to be inserted into the input chute 20. When closed, the lid 25 may form an airtight seal around the upper surface of the input chute 20. Additionally, the lid 25 may be constructed from a transparent material (e.g., glass, plexiglass, etc.) which may allow an operator to visualize material placed into the input chute 20. FIG. 2 illustrates the lid 25 in an open configuration whereby an operator may load raw material (e.g., a spawn grain block) into the input chute 20.

Further, the lid 30 may include an aperture aligned with the bottom rim of the input chute 20. It can be appreciated that the aperture located in the lid 30 may permit material (e.g., spawn grain block) inserted into the input chute 20 (via opening the lid 25) to fall through the input chute 20 and pass through the lid 30, whereby the material may then engage the spinning shredder blade 16. It can be further appreciated that lid 30 may be designed to seal around the bottom rim of the input chute 20, thereby creating an airtight seal between the input chute 20 and the base 12.

FIG. 1 illustrates that the shredder assembly 14 may further include an air filter 18 positioned adjacent to the input chute 20. Additionally, the shredder assembly 14 may also include a fan positioned between the air filter 18 and the input chute 20. In some examples, the air filter 18 may include a HEPA (High Efficiency Particulate Air) filter designed to remove particulates (e.g., bacteria, microorganisms, mildew, etc.) from air passing through the filter 18 and entering the mixing chamber 21.

Further, in some examples, the input chute 20 may include an aperture located in a sidewall of the chute 20 adjacent to both the fan 19 and the air filter 18. Accordingly, it can be appreciated that the fan 19 may be designed to draw air through the filter 18, whereby the filtered air passes into the input chute 20 through the aperture located in the sidewall of the input chute 20. It can be further appreciated that the filtered air may eventually flow into the mixing chamber 21, whereby the filtered air may be introduced to the organic material components of the mushroom substrate. Additionally, filtered air drawn through the input chute 20 may be used to cool and/or oxygenate the mushroom substrate.

Additionally, in some examples, the input chute 20 may further include a second filter (e.g., a second HEPA filter) integrated into the sidewall or top of the input chute 20. Accordingly, air drawn through the HEPA filter 18 by the fan 18 will pass through the chute 20 before passing through the input chute 20 and into the mixing chamber 21. This assures the air is as clean as possible for the introduction of the inoculation agent to the mushroom substrate.

FIG. 1 illustrates that the mixer 10 may be include a first water line 35 passing from outside the base 12 and into the mixing chamber 21, whereby the first water line 35 may then extend lengthwise along an inner surface of a sidewall of the base 12. Inside the mixing chamber 21, the first water line 35 may include one or more openings, apertures, perforations, etc. which permit the water (or other liquid) to be applied (e.g., dispensed, sprayed, sprinkled) onto the mushroom substrate. In other words, the first water line 35 may allow the mushroom substrate to be uniformly hydrated (e.g., wetted) while the mushroom substrate is being agitated (e.g., turned and mixed) by the ribbon agitator 24.

As will be discussed in greater detail herein, the steps of the mushroom cultivation process may require the application of different fluids to the mushroom substrate. For example, some steps may require the application of RO (reverse osmosis) water, UV sterilized water and/or ozone water to the mushroom substrate. Accordingly, in some examples, the first water line 35 may be coupled to a second water line 60 and a third water line 62 via a programmable valve 58. It can be appreciated that the second water line 60 may include a first end connected to the valve 58 (as shown in FIG. 1) and a second end connected to a RO water system and/or a UV water system. Similarly, the third water line 62 may include a first end connected to the valve 58 (as shown in FIG. 1) and a second end connected to an ozone water generator. Accordingly, the second water line 60 may be configured to transport a first liquid (e.g., RO water, UV water, etc.) to the valve 58 and the third water line 62 may be configured to transport a second liquid (e.g., ozone water) to the valve 58.

It can be further appreciated that the valve 58 may selectively permit either the first liquid or the second liquid to pass through the valve 58 and into the first water line 35, whereby either the first liquid or the second liquid is transported into the mixing chamber 21 via the first water line 35. In some examples, the valve 58 may be a programmable valve, whereby the valve 58 is programmed to automatically select either the first liquid or the second liquid to pass through the valve 58, depending on the specific requirements of the mixing process of the mushroom substrate. For example, the valve 58 may be programmed to permit heated ozone water to pass through the valve 58 and into the mixing chamber 21 via the first water line 35 during an initial sterilization of the mushroom substrate, whereby the valve prevents the RO water to pass through the valve 58 and into the first water line 35 while the ozone water is being transported during the initial sterilization step. After the initial sterilization step, the valve 58 may permit RO water to pass through the valve 58 and into the mixing chamber 21 via the first water line 35 to cool down the mushroom substrate, whereby the valve 58 prevents ozone water to pass through the valve 58 and into the first water line 35 while the RO water is being transported during the cool down step.

FIG. 1 further illustrates that the mixer 10 may include a hydration flow meter 64 placed in fluid communication with the first water line 35. The hydration flow meter 64 may be designed to measure (e.g., sense) and communicate the flow rate and volume of a liquid flowing through the first water line 35 and into the mixing chamber 21 of the mixer 10. Additionally, the hydration meter 64 may be designed to measure (e.g., sense) and communicate the moisture content of the mushroom substrate during the mixing process. For example, the hydration flow meter 64 may include a sensing probe positioned within the mixing chamber 21 of the mixer 10 that senses the moisture content of the mushroom substrate and/or the ambient air within the mixing chamber during the various steps of the mixing process of the mushroom substrate. In other words, the hydration flow meter 64 may operate as a humidistat in addition to communicating the flow rate and volume of a liquid flowing through the first water line 35. It is contemplated that, in some examples (such as that shown in FIG. 1), the hydration flow meter 64 may be positioned along an outer surface of the mixer 10. However, in other examples, it is contemplated that the hydration flow meter 64 may be positioned within the mixing chamber of the mixer 10.

FIG. 1 further illustrates that the mixer 10 may include one or more programmable logic controllers 42a, 42b. The controllers 42a, 42b may communicate with one or more components of the mixer 10, including but not limited to the ribbon agitator motor 22, the shredder motor 34, the valve 58, the hydration flow meter 64 and/or a heating element (burner, boiler) attached to the mixer 10. It can be appreciated that the controllers 42a, 42b may be designed to control the rotation speed of the ribbon actuator 24 via communication with the motor 22, the speed of the shredder blade 16 via communication with the motor 34, the flow rate and total volume of water (RO water, ozone water, UV water, etc.) permitted to pass through the first water line 35 via communication with the hydration meter 64, the selection (e.g., switching) of liquid (e.g., RO water, ozone water, UV water) being allowed to pass through the valve 58 and into the first water line 35 and the temperature being maintained in the mixing chamber 21.

Additionally, FIG. 1 illustrates that the mixer 10 may also include a catwalk 72 mounted to the frame 40, the base 12 or other components of the mixer 10. The catwalk 72 may extend lengthwise along the outer surface of the base 12. The catwalk may permit an operator to be raised off the floor such that the operator efficient access the mixing chamber of the mixer 10. For example, the catwalk 72 may permit an operator to be positioned adjacent the first lid 26, the second lid 28, the third lid 30 and or the lid 25 of the shredder assembly 14 to perform actions such as pouring raw materials of the mushroom substrate into the mixing chamber 21 of the mixer 10 and visualizing the mixing of the mushroom substrate via the rotation of the ribbon actuator 24. As discussed herein, the catwalk 72 may permit an operator to walk along the entire length of the base 12, thereby having efficient access to the first lid 26, the second lid 28, the third lid 30, and the lid 25 of the shredder assembly 14.

As discussed herein, FIG. 2 illustrates the opening of the first lid 26 and the second lid 28. While not shown open in FIG. 2, it can be appreciated that the third lid 30 may open similarly to the first lid 26 and the second lid 28. However, it can be further appreciated that the opening of the third lid 30 may include lifting the entire shredder assembly 14 (including the filter 18, fan 19, chute 20, motor 34 and blade 16) along with the lid 30 as the shredder assembly 14 is attached to the lid 30. In other examples, however, the lid 30 may be fixedly attached to the base 12, whereby the lid 30 is not designed to be opened, but rather is sealed in an airtight configuration to the base 12.

FIG. 3 illustrates a portion of the mixer 10 described herein. For clarity, several components (e.g., the first lid 26, the second lid 28, the third lid 30, the chute 20, the filter 18, the fan 19, the catwalk 72, etc.) of the mixer 10 have been hidden from view to show the interior components of the mixer 10. For example, FIG. 3 illustrates the drive shaft 27 (described above) of the shredder motor 34 which couples the shredder motor 34 to the shredder blade 16.

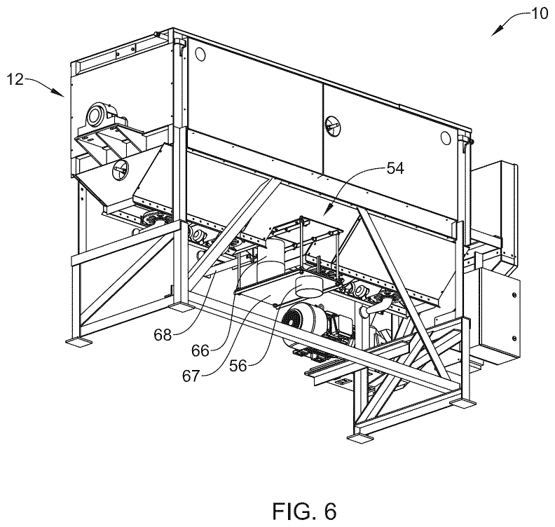

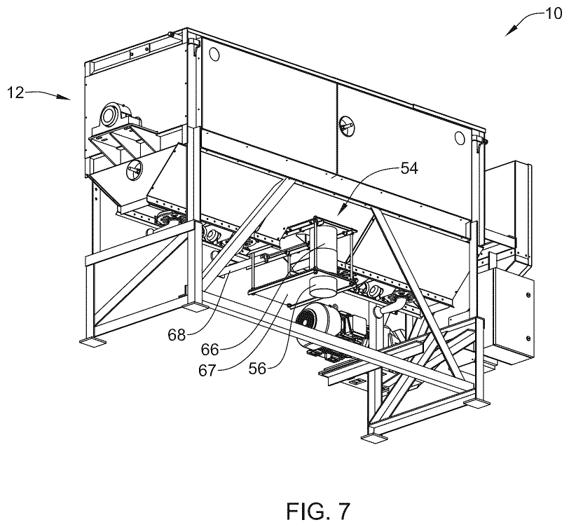

Further, FIG. 3 illustrates that the shaft 32 may be driven by a motor 22. As illustrated in FIG. 3, the motor 22 may be coupled to the shaft 32 via a first gear 32a, a second gear 36b and a drive belt 38. It can be appreciated that the motor 22 may power the rotation of the second gear 36b, which, in turn, powers the drive belt 38 to rotate the first gear 36a, which, in turn, rotates the shaft 32. As discussed herein, the motor 22 may be in communication with one or more of the logic controllers 42a, 42b to control the angular speed of the shaft 32 and the ribbon agitator 24. As discussed above, FIG. 3 further illustrates that the mixer 10 may include an aperture 46 positioned in a central region of the floor of the mixer 10. As will be discussed with respect to FIGS. 6-7, after inoculation of the mixed raw mushroom substrate materials, the mushroom substrate may pass through the aperture 46 and into a discharge chute, whereby the mushroom substrate may be funneled and sealed within a packaging container (e.g., a bag).

FIG. 4 illustrates a partially exploded view of several components of the mixer 10. For example, FIG. 4 illustrates the shaft 32 and the ribbon agitator 24 spaced away from the base 12 of the mixer 10. As illustrated in FIG. 4, the ribbon agitator 24 may include a set of inner and outer helical agitators. An outer ribbon 33 may move material in one direction and the inner ribbon 31 may move material in the opposite direction. The shaft 32 may support the outer ribbon 33 and the inner ribbon 31 via one or more radial arms 37. It can be appreciated that the helical configuration of the outer ribbon 18 may form a tight fit with the lower portion of the sidewalls and the floor of the base 12. It can also be appreciated that the outer ribbon 31 and the inner ribbon 33 may be opposite handed. Accordingly, as the outer ribbon 33 attempts to convey the material in one direction, the inner ribbon 31 may attempt to convey the material in the opposite direction, thereby resulting in the tumbling and mixing of the mushroom substrate.

FIG. 6 illustrates that the mixer 10 may include one or more burners 52 positioned underneath the base 12. As discussed herein, prior to inoculation of the substrate with the spawn, the mushroom substrate may be sterilized via being heated to a given temperature. In some examples, sterilizing the substrate may be performed during a first hydration step via the application of heated ozone water. However, in the event that application of the heated ozone water fails to sufficiently sterilize the substrate, the burners 52 may be utilized to heat the substrate to a temperature sufficient to effectively pasteurize the substrate.

FIG. 6 illustrates four burners 52 positioned on an outer surface of the floor of the base 12. While FIG. 6 illustrates the burners 52 positioned underneath the base 12, it is contemplated that the burners 52 may be positioned along other regions of the base 12. It is further contemplated that the mixer 10 may include more or less than four burners 52. For example, the mixer 10 may include 1, 2, 3, 4, 5, 6, 7, 8 or more burners positioned along the base 12. Further, each of the burners 52 may be connected with a fuel source. thereby permitting the burners 52 to heat the mushroom substrate. Heating the mushroom substrate via the burners 52 may permit the mixer 10 to pasteurize the raw mushroom substrate materials prior to inoculation of the mushroom substrate.

As discussed herein, FIG. 6 illustrates that the mixer 10 may include a discharge assembly 54. The discharge assembly 54 may include an upper discharge chute 66 and a lower discharge chute 56, whereby the lower chute 56 may be fixedly attached to a flat plate 67 attached to the base 12 of the mixer 10. Additionally, the bottom rim of the upper chute 66 may be positioned flat against the plate 67. It can be further appreciated from FIG. 6 that the upper chute 66 may be attached to a powered piston 68 (e.g., compressed air powered piston) which may translate the upper chute 66 along the flat plate 67 (e.g., the bottom rim of the upper chute 66 may slide along the flat plate 67) relative to both the base 12 and the lower chute 56.

For example, FIG. 6 illustrates the upper chute 66 in a first configuration in which the upper chute 66 is aligned with the aperture 46 located in the floor of the base 12. It can be appreciated that in the configuration illustrated in FIG. 6, the inoculated mushroom substrate may fall into the upper chute 66 from the mixing chamber of the mixer 10. In the configuration illustrated in FIG. 6, the substrate is prevented from falling through the upper chute 66 by the plate 67. Further, once the mushroom substrate has filled the upper chute 66, the actuation of the piston 68 may translate the upper chute 66 laterally toward the lower chute 56. It can be appreciated that as the upper chute 66 is translated along the plate 67 and vertically aligned with the lower chute 56, the mushroom substrate within the upper chute 66 may pass from the upper chute 66, through an aperture in the plate 67 and into the lower chute 56. Further yet, while not illustrated in FIG. 7, a packaging container (e.g., a packaging bag) may be attached to the lower chute 56. Accordingly, upon the translation and alignment of the upper chute 66 with the lower chute 56, the mushroom substrate may pass into the packaging container. The packaging container may then be sealed in preparation for the growth phase of the mushrooms.

It can be further appreciated that the piston 68 may be programmable, such that actuation of piston 68 and the subsequent translation of the upper chute 66 may be driven automatically via communication with one or more of the logic controllers 42a, 42b. In other examples, the piston 68 may be actuated via a foot pedal connected to the piston 68, whereby an operator may depress the foot pedal to actuate the piston and translate the upper chute 66 toward the lower chute 56. Other methods of controlling the piston 68 are contemplated. Further, it can be appreciated that after the mushroom substrate has passed through the lower chute 56 and into the packaging container, the piston 68 may retract the upper chute 66 toward the central aperture 46 and repeat the filling cycle.

Further, in some examples, the lower chute 56 may be constructed from one or more individual concentric tubes which permit the lower chute 56 to elongate. For example, the one or more concentric tubes forming the lower chute 56 may be coaxial with respect to one another, thereby permitting the centric tubes to telescope and increase in length. Allowing the lower chute 56 to elongate may permit the lower chute 56 to accommodate different size packaging containers (e.g., polypropylene bags) used to package the mushroom substrate. Breathable polypropylene bags with different filter types are widely used for specialty mushroom production. These bags range in size but an example standard bag may be about 10 cm by 8 cm by 30 cm to larger bags having dimensions of about 20 cm by 12 cm by 50 cm. Filter sizes typically range from 0.02 micron to 0.05 micron.

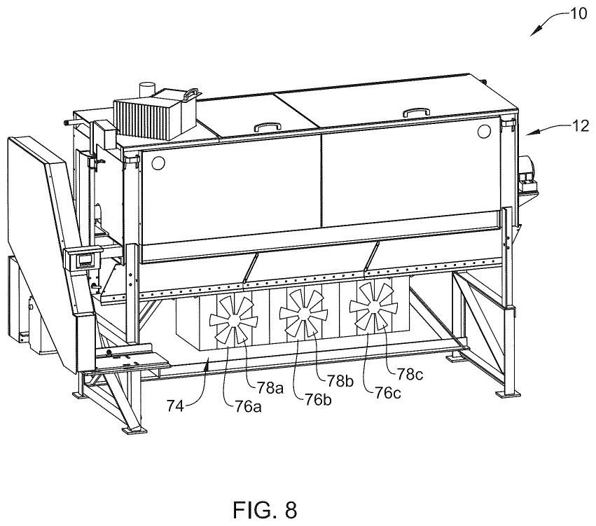

FIG. 8 illustrates that, in some examples, the mixer 10 may include filter flow hood assembly 74 positioned underneath the base 12 of the mixer 10 (the catwalk 72 has been hidden from view in FIG. 8). The filter flow assembly 74 may be positioned adjacent to the discharge assembly 54 described above. The filter flow hood assembly 74 may include one or more filters 78a, 78b, 78c (e.g., HEPA filters) positioned lengthwise along the base 12. Further, the filter flow hood assembly 74 may include one or more fans 76a, 76b, 76c, whereby each of the fans is aligned with a respective filter 78a, 78b, 78c. The fans 76a, 76b, 76c may be designed to blow clean, filtered air across the bottom width of the mixer 10 from a position behind the discharge assembly 54 (include the upper chute 66 and lower chute 56) toward the lower chute 56 during the bagging of the inoculated mushroom substrate.

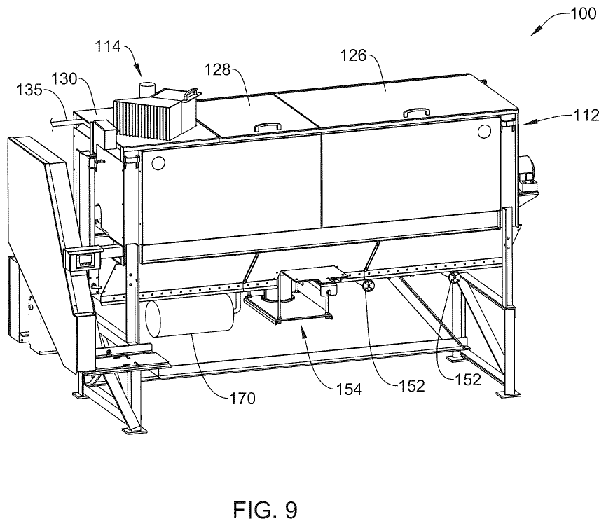

FIG. 9 illustrates another example mixer 100. The mixer 100 may be similar in form and function to the mixer 10 described herein. For example, the mixer 100 may include a base 112, a first lid 126, a second lid 128 and a third lid 130, whereby the base 112, the first lid 126, the second lid 128 and the third lid 130 may be similar in form and function to the base 12, the first lid 26, the second lid 28 and the third lid 30 described above. Further, the mixer 100 may include a shredder assembly 114, water line 135, discharge assembly 154 and one or more burners 152 which are all similar in form and function to the shredder assembly 14, water line 35, discharge assembly 54 and burners 52 described above.

Additionally, FIG. 9 illustrates that the mixer 100 may include a boiler 170 positioned underneath the base 112. It can be appreciated that the boiler 170 may be attached to a water inlet line. Accordingly, it can be further appreciated that the boiler 170 may be designed to generate energy to heat water to produce steam which may subsequently flow from the boiler 170 into the mixing chamber of the mixer 110.

As discussed herein, the mushroom substrate may need to be sterilized or pasteurized prior to the introduction of the spawn. As discussed herein, sterilization may be accomplished via the application of ozone water. In other examples, pasteurization may be accomplished via the heating of the substrate via the burners 52. Further, the mixer 100 illustrates that pasteurization may, alternatively, be accomplished via the injection of steam into the mixing chamber 21. As discussed above, the mixer 100 may effectively operate as an autoclave, whereby steam is injected into the mixing chamber 21 to elevate the temperature of the mushroom substrate at a specific pressure and over a specific time period sufficient to pasteurize the substrate. In some examples, the steam produced by the boiler 170 may be designed to heat the mushroom substrate. Further, as discussed herein, the mixer 100 may be sealed in an airtight configuration during the injection of the steam into the mixing chamber 21, thereby permitting the mushroom substrate to be held at the necessary temperature and pressure (over a specific time period) necessary to pasteurize the mushroom substrate. It can be appreciated that all components of the mixer 10 positioned in the sealed mixing chamber 21 during the sterilization and/or pasteurization step may be sterilized. For example, the shredder blade 16, which is positioned within the mixing chamber 12, may be sterilized during the sterilization and/or pasteurization of the mushroom substrate. It can be further appreciated that, in some examples, ozone water may be added to the substrate during the pasteurization process to oxygenate the substrate. Alternatively, carbonated water may be used to enhance the carbon concentration.

FIG. 9 illustrates that the boiler 170 may be positioned adjacent to one or more burners 152. In some examples, such as that illustrated in FIG. 9, the mixer 100 may include both a boiler 170 and one or more burners 152. This hybrid design of the mixer 100 including both a boiler 170 and burners 152 may allow an operator to treat the mushroom substrate with direct heat from the burners 152, steam from the boiler 170, or a combination of direct heat from the burners 152 and steam from the boiler 170. While, in some instances, the burners 152 may be utilized to heat the mushroom substrate during a sterilization step prior to the inoculation of the substrate, in other examples, the burners 152 may be utilized in conjunction with the boiler 170 to pasteurize the mushroom substrate using heat generated from the burners 152 and steam generated from the boiler 170.

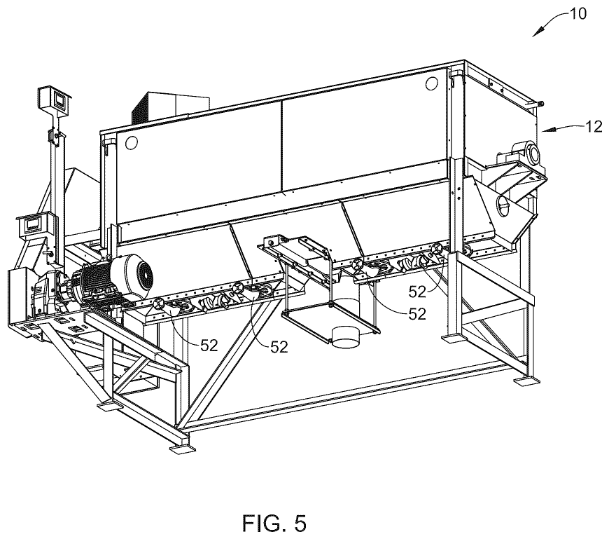

As discussed above, in some examples, the mixer 100 may include both the boiler 170 and one or more burners 152. However, it can be appreciated that, in other examples, the mixer 100 may include only a steam boiler 170. In yet other examples, such as that described above with respect to FIG. 5, the mixer 100 may only include the one or more burners 152.

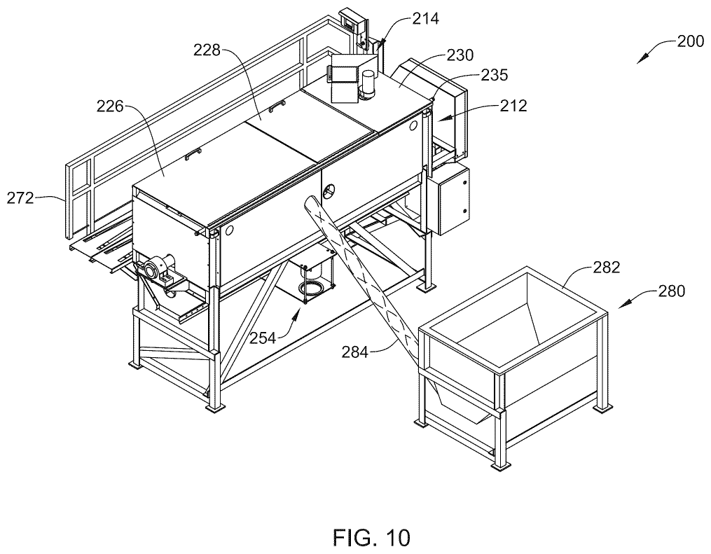

FIG. 10 illustrates another example mixer 200. The mixer 200 may be similar in form and function to the mixers 10, 100 described herein. For example, the mixer 200 may include a base 212, a first lid 226, a second lid 228 and a third lid 230, whereby the base 212, the first lid 226, the second lid 228 and the third lid 230 may be similar in form and function to the base 12, the first lid 26, the second lid 28 and the third lid 30 described above. Further, the mixer 200 may include a shredder assembly 214, water line 235, discharge assembly 254, one or more burners (not visible in FIG. 10), an optional boiler (not visible in FIG. 10) which are all similar in form and function to the shredder assembly 14, water line 35, discharge assembly 54, burners 52 and boiler 170, described above.

Additionally, FIG. 10 illustrates that the mixer 200 may be attached to a hopper auger feeder system 280. The hopper auger feeder system 280 may include a hopper 282 which may be designed to hold bulk materials used to manufacture the mushroom substrate. Further, the bulk materials placed in the hopper 282 may be fed into the mixing chamber of the mixer 200 via an auger 284. It can be further appreciated that the auger 284 may communicate with one or more of the controllers 42a, 42b, whereby an operator may utilize one or more of the controllers 42a, 42b to control the speed at which the raw materials are fed into the mixing chamber of the mixer 200.

Using the mixer 10, 100, 200 described herein may permit an operator to cultivate mushrooms in a batch process, thereby performing a series of cultivation steps within a single, multi-functional mixer 10, 100, 200. The batch cultivation process may initially include loading one or more raw substrate materials (e.g., saw dust, soy hulls) and nutrients (e.g., nitrogen, protein) in the mixing chamber of the mixer 10, 100, 200. As described herein, loading the raw materials into the mixing chamber may include opening the first lid 26, 126, 226 or the second lid 28, 128, 228 and pouring the raw materials into the mixing chamber 21.

Next, the motor 22 may be powered to rotate the ribbon agitator 24 to begin mixing the raw mushroom substrate materials together. Next, in a first hydration and sterilization step, heated ozone water may be transported through the second fluid line 60, through the valve 58, through the first fluid line 35 whereby it is released through the apertures in the fluid line 35 within the mixing chamber such that it is substantially uniformly distributed over the substrate. The heated ozone water may increase the temperature and moisture content of the substrate to a point at which the substrate is sufficiently sterilized and hydrated. It can be appreciated that the mixer 10, 100, 200 may include pressure relief valve designed to release air during the heating of the substrate.

The hydration flow meter 64 may be utilized as a humidistat to determine and monitor the moisture content of the substrate. Further, the controls 42a, 42b may automatically determine that additional ozone water needs to be applied to achieve a desired moisture content of the substrate. If the sterilization step fails, pasteurization with the application of heat via the burners 52, 152 and/or the steam via the boiler 170 may be performed.

Once sufficiently sterilized/pasteurized, RO water and/or UV water may be transported through the second fluid line 60, through the valve 58, through the first fluid line 35 whereby it is released through the apertures in the fluid line 35 within the mixing chamber 21 such that it is uniformly distributed over the substrate. The RO water and/or UV water may be cold water relative to the temperature of the substrate, whereby the cold water is applied to cool the sterilized substrate. Additionally, filtered air may be drawn through the input chute 20 and into the mixing chamber to assist in cooling of the substrate. Alternatively, in some examples, filtered air may be drawn through the input chute 20 and into the mixing chamber may be the only mechanism to cool the substrate. Further, in other examples, the side walls of the mixer 10 may include channels, tubes, piping, pathways, etc. through which cold water is filled and cycled to accelerate the cooling process of the mushroom substrate. It can be appreciated that the application of RO water/UV water, the filtered air, and the water in the sidewalls may be utilized individuals or in any combination to cool the mushroom substrate.

After the substrate is sufficiently cooled, a grain spawn block may be inserted into the input chute 20 and passed through the spinning shredder blade 16. The shedder blade 16 may break up the grain spawn block into smaller pieces which are evenly dispersed and mixed by the ribbon agitator 24 into the sterilized mushroom substrate in an inoculation step.

It can be appreciated that in a batch mushroom cultivation process, the mushroom substrate may be inoculated within the mixing chamber 21 at higher ratios of spawn-to-substrate as compared to conventional mushroom cultivation methods. For example, in a batch cultivation process (such as the processes disclosed herein), the ratio of spawn to substrate may be about 1 part spawn to 6 parts substrate, or about 1 part spawn to about 8 parts substrate, or about 1 part spawn to 10 parts substrate, or about 1 part spawn to about 12 parts substrate, or about 1 part spawn to 14 parts substrate, or about 1 part spawn to about 16 parts substrate, or about 1 part spawn to about 18 parts substrate, or about 1 part spawn to about 20 parts substrate, or about 1 part spawn to 22 parts substrate, or about 1 part spawn to about 24 parts substrate, or about 1 part spawn to about 26 parts substrate, or about 1 part spawn to 28 parts substrate, or about 1 part spawn to about 30 parts substrate. Increasing the amount of spawn relative to the substrate (as compared to traditional cultivation processes) may provide the mycelium a shorter distance to grow between leap-off points, thereby increasing the efficiency (time) for the mycelium to form a fully colonized substrate bag in preparation for the fruiting process. Additionally, the ratio of spawn to substrate may vary depending on the specific type of mushroom being cultivated.

After inoculation, the substrate may be discharged through the discharge chute, bagged and sealed.

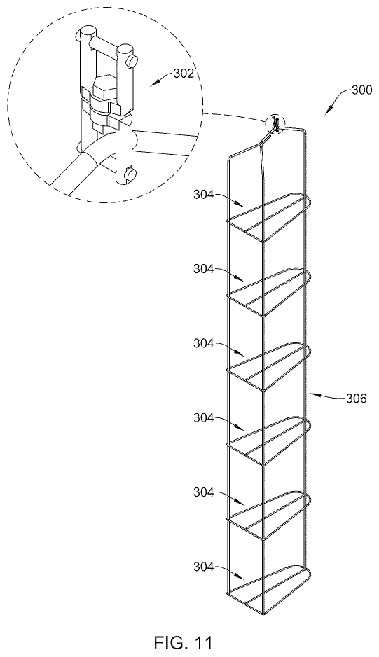

FIG. 11 illustrates an example wire rack 300. The wire rack 300 may be used to store individual bags of inoculated substrate during a colonization step. The wire rack may 300 may include a vertical frame 306 and one or more horizontal shelves 304 coupled thereto. The vertical frame 306 and/or vertical shelves 304 may be formed from a single wire which is shaped (e.g., bent, curved, etc.) into the configuration illustrated in FIG. 11.

As illustrated in FIG. 11, the vertical frame 306 may include three vertically extending support members. In other examples, the vertical frame 306 may be formed by attaching (e.g., welding) multiple individual support members together. While the wire rack 300 illustrated in FIG. 11 shows three support members, it is not intended to be limiting. Rather, the wire rack 300 may include 1, 2, 3, 4, 5, 6 or more vertical support members. In some embodiments, the horizontal shelves 304 may be formed as separate components that are attached to the vertical frame 306 in a subsequent manufacturing step.

FIG. 11 illustrates that the wire rack 300 may include six horizontal shelves 304 vertically aligned within one another along the vertical frame 306. While the wire rack 300 illustrated in FIG. 11 shows six horizontal shelves 304, it is not intended to be limiting. Rather, the wire rack 300 may include 1, 2, 3, 4, 5, 6, 7, 8, 9, 10, 11, 12 or more horizontal shelves.

It can be appreciated that each horizonal shelf of the wire rack 300 may be designed to hold a single bag of inoculated mushroom substrate. After an operator removes a bag of inoculated substrate from the mixer 10, the operator may place the individual bag of inoculated substrate on a single shelf 304 of the wire rack 300. It can be appreciated that the shelves 304 of the rack 300 may be designed to properly space the bags of inoculated substrate away from one another, thereby assuring optimal air flow around each individual bag during colonization of the mushrooms. However, it can be appreciated that the rack 300 may be sized to accommodate more than one bag of substrate per shelf 304. For example, the rack 300 may be sized to accommodate 1, 2, 3, 4, or more bags of mushroom substrate per shelf 304, while still assuring optimal air flow around each individual bag during colonization of the mushrooms.

In some instances, the wire rack 300 may be designed to be utilized with an automated conveyor system utilized to move the blocks of inoculated mushroom substrate between various areas of the mushroom cultivation facility. In some examples, the rack 300 may be designed to be hung from an overhead conveyor system. Accordingly, the detailed view of FIG. 11 illustrates that the rack 300 may include a swivel-hook component 302 disposed along an upper region of the frame 306 of the rack 300. The swivel-hook component 302 may permit the rack 300 to be hung from one or more components of a conveyor system for automated or manual transportation of the racks 300 around mushroom cultivation facility.

Additionally, while harvesting the mushroom crop, the swivel-hook component 302 may permit an operator to remain stationary and yet easily rotate the rack 300 to access all sides of the mushroom blocks. The design of the rack 300 allows the operator to access each mushroom block on each shelf 304 from each direction, while remaining in a stationary position.

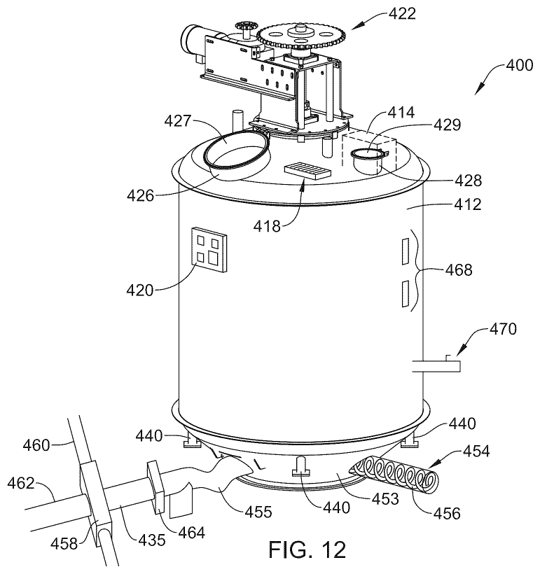

FIG. 12 illustrates a perspective view of an example single stage vertical mixer 400. Like other mixers described herein, the vertical mixer 400 may be utilized to streamline the production process of preparing mushroom substrate. For example, a batch inoculation process using the vertical mixer 400 is disclosed herein. The batch inoculation methodology described herein eliminates the need for a clean room and inoculation equipment (e.g., petri dishes or syringes). An Example of a batch inoculation process using the vertical mixer 400 is disclosed below.

As disclosed herein, the mixer 400 may be utilized as a standalone, single stage mushroom mixer capable of performing multiple steps of a batch mushroom substrate cultivation process. For example, the mixer 400 may be utilized to combine (e.g., mix) raw material ingredients to form a mushroom substrate, sterilize the substrate, hydrate the substrate, prepare and introduce spawn into the substrate (e.g., inoculation of the substrate), transport the substrate and bag the inoculated substrate. In other words, the single stage mixer 400 may be designed to perform batch inoculation of a mushroom substrate.

Further, like other mixes described herein, the mixer 400 may be designed to maintain its own sterile environment, thereby maintaining the sterility of the mushroom substrate while the steps of the mushroom cultivation process are performed.

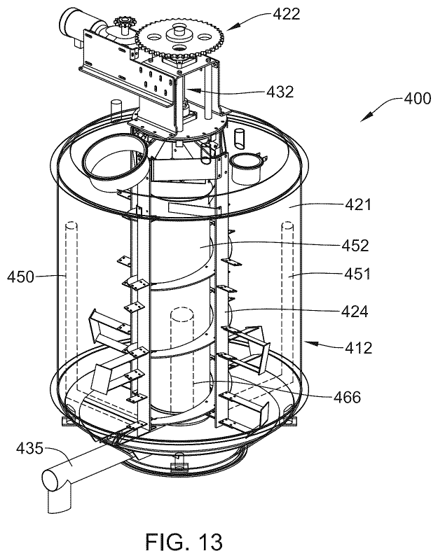

As illustrated in FIG. 12, the single stage mixer 400 may be a vertical mixer. The mixer 400 may include a substantially vertical (e.g., upright), cylindrical tank 412 (e.g., a mixing container, chamber, base, etc.) attached to a rigid framework 440. The tank 412 may include an insulated jacket. The framework 440 may include one or more support posts (e.g., legs, feet, etc.) designed to level and attach the vertical tank 412 to the floor. The tank 412 may include a bottom hatch or door 453 having an exit port which can be utilized when bagging inoculated mushroom substrate. The door 453 may be sealed during the sterilization cycle. The interior cavity of the tank 412 may define a mixing chamber 421 (shown in FIG. 13).

FIG. 12 illustrates that the mixer 400 may further include a manway 426 (e.g., access port, hatch, etc.) positioned along an upper surface of the tank 412. The manway 426 may provide an access point to the inner chamber of the tank 412. The manway 426 may be designed to form an airtight seal along the upper surface of the tank 412. For example, the manway 426 may include a circular, square, rectangular or other suitable shape that mates with the shape (e.g., dimensions) defined by an upper surface of the tank 412.

FIG. 12 illustrates that the manway 426 may include a lid 427 which is attached to a portion of the upper surface of the tank 412 via a hinge, whereby the hinged attachment may allow the lid 427 to be opened while still maintaining the hinged attachment to the base 412. Additionally, the lid 427 may include a handle designed to permit an operator to lift the lid 427, thereby allowing the operator access into the mixing chamber 421 (shown in FIG. 12) of the tank 412. It can be appreciated that an operator may place the organic material, nutrients, etc. used to make the mushroom substrate into the mixing chamber 421 of the tank 412 via accessing the openings defined by manway 426 by opening the lid 427. The organic material, nutrients, etc. used to make the mushroom substrate may be inserted through the manway 426 and into the mixing chamber 421 prior to a sterilization cycle.

Additionally, the lid 427 may be constructed of a transparent material. For example, the lid 427 may be formed from glass, plexiglass or the like. Constructing the lid 427 from a transparent material may allow an operator to easily visible the mixing of the materials place in the mixing chamber 421 of the tank 412. As discussed herein, each of the lid 427 may include one or more features with permit the lid 427 to form an airtight seal along the upper surface of the tank 412.

FIG. 12 illustrates that the mixer 400 may further include an inoculation port 428 (e.g., inoculation access port, hatch, etc.) positioned along an upper surface of the tank 412. The inoculation port 428 may provide an access point to the inner chamber of the tank 412. The inoculation port 428 may be designed to form an airtight seal along the upper surface of the tank 412. For example, the inoculation port 428 may include a circular, square, rectangular or other suitable shape that mates with the shape (e.g., dimensions) defined by an upper surface of the tank 412.

FIG. 12 illustrates that the inoculation port 428 may include a lid 429 which is attached to a portion of the upper surface of the tank 412 via a hinge, whereby the hinged attachment may allow the lid 429 to be opened while still maintaining the hinged attachment to the tank 412. Additionally, the lid 429 may include a handle designed to permit an operator to lift the lid 429, thereby allowing the operator access into the mixing chamber 421 of the tank 412. It can be appreciated that an operator may place the grain spawn or other materials used to inoculate the mushroom substrate into the mixing chamber 421 of the tank 412 via accessing the openings defined by inoculation port 428 by opening the lid 429.

Additionally, the lid 429 may be constructed of a transparent material. For example, the lid 429 may be formed from glass, plexiglass or the like. Constructing the lid 429 from a transparent material may allow an operator to easily visible the mixing of the materials place in the mixing chamber 421 of the tank 412. As discussed herein, each of the lid 429 may include one or more features with permit the lid 429 to form an airtight seal along the upper surface of the tank 412.

FIG. 12 illustrates that the mixer 400 may further include an air filter assembly 418 positioned along a surface of the tank 412. For example, FIG. 12 illustrates the air filter assembly positioned along an upper surface of the tank 412. In some examples, a positive pressure fan and a HEPA filter may be combined into a single component of the air filter assembly 418 mounted on an outer surface of the tank 412. The air filter assembly may include a filter (e.g., HEPA filter) and/or a positive pressure fan positioned adjacent to an aperture, port, hatch, valve, etc. which communicates with the mixing chamber 421. The air filter assembly 418 may be designed to draw filtered air into the mixing chamber 421 of the tank 412 through the filter. Filtered air drawn into the mixing chamber 421 of the tank 412 may provide a positive pressure within the mixing chamber 421 of the tank 412. In some examples, the mixer 400 may include a plurality of air filter assemblies 418 positioned along a surface of the tank 412.

Additionally, FIG. 12 illustrates that the mixer 400 may further include an air filter hood assembly 414 positioned adjacent to the inoculation port 428. For example, the air filter hood assembly 414 may be positioned above the inoculation port 428. In other examples, the air filter hood assembly 414 may substantially surround the inoculation port 428. The air filter hood assembly 414 may include a HEPA filter and/or a positive pressure fan. In some examples, a positive pressure fan and a HEPA filter may be combined into a single component of the air filter hood assembly 414. In yet other examples, the air filter hood assembly 414 may include a valve which extends through the inoculation port 428 and which may be closed during the sterilization cycle or any other processing cycle (e.g., cook cycle) of the mushroom substrate. It can be appreciated that a fan of the air filter hood assembly 414 may be designed to draw air through the HEPA filter, whereby the filtered air passes into the mixing chamber 421 of the tank 412 through the inoculation port 428 located in the upper surface of the tank 412. It can be appreciated that the filtered air may be introduced to the organic material components of the mushroom substrate within the mixing chamber 421 of the tank 412. Additionally, filtered air drawn through the air filter hood assembly 414 may be used to cool and/or oxygenate the mushroom substrate. In yet other examples, the air filter hood assembly 414 may be integrated with the inoculation port 428. For example, the filter assembly 414 may include a flow hood, a fan and/or a HEPA filter which may be coupled to a portion of the lid 429 of the inoculation port 428.

Similar to that described above with respect to the mixer 10, the mixer 400 may further include a shredder assembly. The shredder assembly may be similar in form and function to the shredder assembly 14 described herein. For example, the shredder assembly may include a drive motor coupled to a shredder blade. The drive motor may be similar in function to the drive motor 34 described herein. The shredder blade may be similar in form and function to the shredder blade 16 described herein. The drive motor of the shredder assembly may be designed to provide power to spin the shredder blade of the shredder assembly. The shredder blade of the shredder assembly may be positioned within the mixing chamber 421 of the tank 412 while the drive motor of the shredder assembly may be positioned on an outer surface of the tank 412. Accordingly, a drive shaft may extend through a lid of the shredder assembly, whereby the drive shaft may couple the drive motor to the shredder blade of the shredder assembly. The lid 431 may be designed to seal around the drive shaft of the shredder assembly extending therethrough, thereby assuring that the lid 431 can maintain an airtight seal between the drive shaft of the shredder assembly and the tank 412, as described above. It can be appreciated that a grain spawn block may be inserted into the shredder assembly and passed through the spinning shredder blade of the shredder assembly. The shedder blade of the shredder assembly may break up the grain spawn block into smaller pieces which are evenly dispersed into the sterilized mushroom substrate in an inoculation step.

FIG. 12 illustrates that the mixer 400 may be include a first water line 435 passing from outside the tank 412 and into the mixing chamber 421 of the tank 412, whereby the first water line 435 may then extend to one or more hydration lines 450 (shown in FIG. 13) positioned inside the mixing chamber 421 of the tank 412. While FIG. 13 illustrates a single side mounted hydration line 450, it is contemplated that the mixer 400 may include 1, 2, 3, 4, 5, 6 or more side mounted hydration lines 450 positioned inside the mixing chamber 421 of the tank 412. The one or more hydration lines 450 may be utilized to hydrate mushroom substrate positioned in the tank 412. Inside the mixing chamber 421 of the tank 412, the one or more hydration lines 450 may include one or more openings, apertures, perforations, etc. which permit the water (or other liquid) to be applied (e.g., dispensed, sprayed, sprinkled) onto the mushroom substrate. In some examples, the mixer 400 may include a second water line 451 passing from outside the tank 412 and into the mixing chamber 421 of the tank. The second water line 451 may be utilized to fill the tank 412. Additionally, in some examples a UV filter may be positioned in the first water line 435. Further, in some examples, the first water line 435 may include a bend 455 (e.g., dip, etc.), whereby the bend 455 is designed to prevent air from flowing back into the sterilized mushroom substrate.

Additionally, the first water line 435 may also extend to a water pipe 452 (shown in FIG. 13) positioned inside the mixing chamber 421 of the tank 412. The water pipe 452 may include a first end which is attached to an inner surface of the tank 412. The water pipe 452 may also include a second end which is open to the mixing chamber 421 of the tank 412. Accordingly, inside the mixing chamber 421 of the tank 412, water may enter the water pipe 452 via the first water line 435 along a bottom region of the water pipe 452, whereby the water may then be permitted to fill up and then overflow out of the top of the water pipe 452. It can be appreciated that water which overflows out of the top of the water pipe 452 may be applied (e.g., dispensed, sprayed, sprinkled) onto the mushroom substrate.

In some examples, the mixer 400 may include only the one or more hydration lines 450, only the water pipe 452 or may include both the one or more hydration lines 450 and the water pipe 452. As discussed herein, the mixer 400 may be designed such that water may be provided to the one or more hydration lines 450 and/or the water pipe 452 via the first water line 435.

Additionally, during a cool down cycle of the mushroom substrate sterilization process, excess heat may be removed from the mixing tank and the temperature of the mushroom substrate may be lowered by continuously refilling and dumping cold water from the center water pipe 452. This fill-and-dump cycle may shorten the time to reach a substrate temperature of approximately 90 degrees from approximately 48 hours to 8 hours. In some examples, the water pipe 452 may include an autofill mechanism in which a sensor monitors the amount of water in the water pipe 452 and automatically calls for water to be supplied from the first water line 435 to refill the water pipe 452 to a desired level. This sensor may be in communication with a hydration flow meter 464, which will be described in greater detail below. Alternatively, ice cubes could be inserted into the mixing chamber 421 through the manway 426, for example, and mixed with the organic substrate.

As discussed herein, the steps of the mushroom cultivation process may require the application of different fluids to the mushroom substrate. For example, some steps may require the application of RO (reverse osmosis) water, UV sterilized water and/or ozone water to the mushroom substrate. Accordingly, in some examples, the first water line 435 may be coupled to a second water line 460 and a third water line 462 via a programmable valve 458. It can be appreciated that the second water line 460 may include a first end connected to the valve 458 (as shown in FIG. 12) and a second end connected to a RO water system and/or a UV water system. Similarly, the third water line 462 may include a first end connected to the valve 458 (as shown in FIG. 12) and a second end connected to an ozone water generator. Accordingly, the second water line 460 may be configured to transport a first liquid (e.g., RO water, UV water, etc.) to the valve 458 and the third water line 462 may be configured to transport a second liquid (e.g., ozone water) to the valve 458.

FIG. 12 further illustrates that the mixer 400 may include a hydration flow meter 464 placed in fluid communication with the first water line 435. The hydration flow meter 464 may be designed to measure (e.g., sense) and communicate the flow rate and volume of a liquid flowing through the first water line 435 and into the mixing chamber 421 of the tank 412. Additionally, the hydration meter 464 may be designed to measure (e.g., sense) and communicate the moisture content of the mushroom substrate during the mixing process. For example, the hydration flow meter 464 may include a sensing probe positioned within the mixing chamber 421 of the tank 412 that senses the moisture content of the mushroom substrate and/or the ambient air within the mixing chamber 421 during the various steps of the mixing process of the mushroom substrate. In other words, the hydration flow meter 464 may operate as a humidistat in addition to communicating the flow rate and volume of a liquid flowing through the first water line 435. It is contemplated that, in some examples (such as that shown in FIG. 12), the hydration flow meter 464 may be positioned along an outer surface of the mixer 400. However, in other examples, it is contemplated that the hydration flow meter 464 may be positioned within the mixing chamber 421 of the tank 412.

FIG. 12 further illustrates that the mixer 400 may include one or more controllers 420. The controllers 420 may communicate with one or more components of the mixer 400, including but not limited to a ribbon agitator motor 422, the motor of the shredder assembly 414, the valve 458, the hydration flow meter 464 and/or a heating element 466 (shown in FIG. 13) positioned within the water pipe 452 (shown in FIG. 13). It can be appreciated that the controllers 420 may be designed to control the rotation speed of a ribbon actuator 424 (shown in FIG. 13) via communication with the motor 422, the speed of the shredder blade of the shredder assembly 414, the flow rate and total volume of water (RO water, ozone water, UV water, etc.) permitted to pass through the first water line 435 via communication with the hydration meter 464, the selection (e.g., switching) of liquid (e.g., RO water, ozone water, UV water) being allowed to pass through the valve 458 and into the first water line 435 and the temperature being maintained in the mixing chamber 421. Alternatively, the controllers 420 may be positioned away from the tank 412 and communicate with the sensors 468, etc. through a wire or wireless connection.

FIG. 12 further illustrates that the mixer 400 may include one or more sensors 468. The sensors 468 may include one or more of a pressure sensor, water fill level sensor for the water pipe 452, a hydration flow meter sensor, a water temperature sensor, an internal tank temperature sensor. It can be appreciated that the one or more sensors 468 may communicate with one or more of the controllers 420.

FIG. 12 further illustrates one or more pressure relief valves 470 may be mounted on an outer surface of the tank 412. The pressure relief valve 470 may communicate with the mixing chamber 421. The pressure relief valve 470 may be used to control or limit the pressure within the tank 412. Excess pressure in the tank 412 may be relieved by allowing the pressurized air, fluid, etc. to flow from the mixing chamber 421 out of the tank 412 through the pressure relief valve 470. The relief valve 470 may be designed or set to open at a predetermined set pressure. For example, the components of the tank 412 may be designed such that the tank 412 holds pressure, whereby the pressure relief valve 470 opens when a threshold pressure is reached within the mixing chamber 421. Further, the pressure relief valve 470 may be in communication with a pressure sensor 468. The pressure sensor 468 may communicate with a temperature sensor, the heating element 466, the pressure relief valve 470, or other components of the mixer 400 to define a pressure feedback system which maintains the pressure within the mixing chamber 421.

FIG. 12 further illustrates that the mixer 400 may further include a discharge assembly 454. The discharge assembly 454 may include an automated auger 456. The automated auger 456 may be motor-driven. Additionally, the automated auger 456 may communicate with one or more of the sensors 468 and/or the controllers 420 to control the speed of the auger 456, amount of substrate passed along the auger 456, etc. Further, the auger 456 may be designed to transfer the inoculated mushroom substrate from the mixing chamber 421 of the tank 412 to a bagging location whereby the inoculated mushroom substrate may be bagged and sealed in preparation for the remaining stages of mushroom cultivation.

As discussed herein, FIG. 13 illustrates that the mixer 400 may further include a vertical ribbon agitator 424 positioned within the mixing chamber 421 of the tank 412. Note that various components of the mixer 400 shown in FIG. 12 have been removed from FIG. 13 for clarity purposes. The vertical ribbon agitator 424 may wrap circumferentially around the water pipe 452. In other words, the vertical ribbon agitator 424 may include a central lumen within which the water pipe 452 may extend. Further, the outer extent of the vertical ribbon agitator 424 may be spaced equidistant from the inner surface of the tank 412. A driveshaft 432 may extend from the motor 422 and connect to an upper region of the ribbon agitator 424. It can be appreciated the driveshaft 432 and, consequently, the ribbon agitator 424, may be driven by the motor 422. In some examples, the ribbon agitator 424 may be similar in form and function to the ribbon agitator described herein. For example, the ribbon agitator 424 may be designed to spin in a clockwise or counterclockwise direction to mix the various organic materials, nutrients, spawn, etc. positioned in the mixing chamber 421 of the tank 412. Further, the motor 422 may be in communication with one or more of the controllers 420 to control the angular speed of the driveshaft 32 and the ribbon agitator 424.

As discussed herein, FIG. 13 illustrates that the mixer 400 may include a heating element 466 positioned within the water pipe 452. The heating element 466 may be attached to the base of the tank 412. Further, as illustrated in FIG. 13, the heating element 466 may extend from a bottom region of the water pipe 452 toward an upper region of the water pipe 452. In some examples, the upper end of the heating element 466 may be positioned approximately midway along the water pipe 452. In other words, the end of the heating element 466 which is not attached to the base of the tank 412 may be positioned between the bottom (e.g., bottom, base) end of the water pipe 452 and the upper end of the water pipe 452. It can be appreciated that the heating element 466 may be utilized to heat water within the water pipe 452, whereby the heated water (e.g., boiling water) creates pressure within the mixing chamber 421 during the sterilization cycle or any other processing cycle (e.g., cook cycle). Further, the heating element 466 may be in communication with the one or more of the sensors 468 and/or controllers 420. When the water pipe 452 and the heating element 466 are positioned above a predetermined “substrate fill line,” the mixer 400 may operate as a pressure cooker.

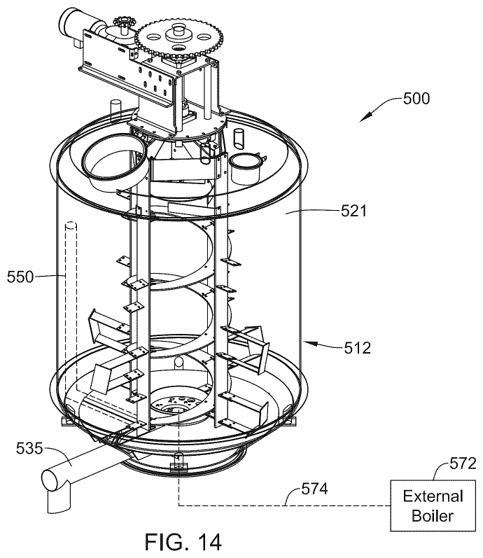

FIG. 14 illustrates another example mixer 500. The mixer 500 may be similar in form and function to the mixer 400 described herein. However, instead of utilizing the water pipe 452 and the heating element 466 to heat the mushroom substrate, the mixer 500 may include a steam boiler 572 positioned adjacent to the tank 512. It can be appreciated that the steam boiler 572 may be in communication with the mixing chamber 521 of the tank 512 via a steam inlet line 574. Accordingly, it can be further appreciated that the boiler 572 may be designed to generate energy to heat water to produce steam which may subsequently flow from the boiler 572 into the mixing chamber 521 of the tank 512. Additionally, the mixer 500 may include an auger similar in form and function to the automated auger 456 described herein. The auger may be positioned in a central region of the mixer 500. Additionally, more than one auger may be incorporated into the mixer 500.

While not shown in FIG. 14, it is contemplated that the mixer 500 may include one or more hydration lines 550 similar in form and function to the hydration lines 450 described above with respect to the mixer 400. The hydration lines may be coupled to the water line 535 passing from outside the tank 512 and into the mixing chamber 521 of the tank 512.

The disclosure may be further clarified by reference to the following Examples, some of which are prophetic in nature, and serve to exemplify some embodiments, and not to limit the disclosure in any way.

### Example 1—Bulk Inoculation of Mushroom Substrate Using a Single Stage Mixer

Achieving sterilization of a mushroom substrate using a single stage vertical mixer may focus on controlling various parameters, including, but not limited to steam, pressure, temperature, and time. To achieve sterilization of a mushroom substrate, a center water pipe positioned within a vertical mixing tank was filled with reverse osmosis water. All openings, lids, apertures, valves in the tank were then closed. A heating element positioned within the water pipe was turned on and the water was heated to boiling. The water was boiled for a time period sufficient to sterilize any residue in the mixing tank. Excess water vapor was collected in a condensation tank. After approximately 30 minutes, the heating element was turned off.

The mixing chamber of the tank was filled with a mushroom substrate including a 50/50 mix of sawdust and soyhulls. Alternatively, 100% millet may be used in place of the sawdust/soyhulls mix. The mushroom substrate was loaded through a manway access port located along an upper surface of the mixing tank. Alternatively, the mushroom substrate may be loaded into the mixing tank through an inoculation port. After the desired amount of mushroom substrate was loaded into the mixing chamber of the mixing tank, the manway was sealed and locked.

Next, the heating element in the water pipe was restarted. Heating of the water in the water pipe resulted in water vapor accumulating within the mixing chamber. The water vapor created pressure within the mixing chamber and began to warm the mushroom substrate and metal surfaces within the mixing chamber. Water condensed within the mixing chamber and combined with the mushroom substrate. The condensed water vapor contributed to 10-20% of the amount of water necessary to achieve the targeted 50-70% (e.g., 60%) hydration of the mushroom substrate. No other water was added during the sterilization of the mushroom substrate.

The water level in the water pipe was continually monitored and is automatically refilled to a desired level during the sterilization cycle (e.g., cook cycle). A hydration flow meter tracked the amount of water added to the water pipe during the sterilization cycle. The makeup water was supplied to the water pipe via a first water line.

The pressure in the mixing chamber was monitored via a pressure sensor. Once the pressure in the mixing chamber reaches between 10-20 psi (e.g., 15 psi) and between 225-275 (e.g., 250) degrees, the organic substrate is held at 10-20 psi (e.g., 15 psi) for approximately 3 hours. During this time, a ribbon agitator continually turned over the mushroom substrate. The combination of pressure, time and agitation assures that all the mushroom substrate within the mixing chamber is sufficiently sterilized and hydrated. The pressure sensor continually monitors and a pressure feedback system assures the 10-20 psi (e.g., 15 psi) pressure is maintained within the mixing chamber for at least the 3 hours.

A cool down cycle begins after the sterilization cycle (e.g., cook cycle) of the mushroom substrate is complete. The cool down cycle began by draining the hot water pipe. The pressure in the mixing chamber was then released through a pressure relief valve. The water pipe was then refilled with cold reverse osmosis water. The reverse osmosis water from the water pipe hydrates the mushroom substrate. The chilled reverse osmosis water was refilled in the water pipe until the mushroom substrate was hydrated to 60% hydration. The temperature of the mushroom substrate dropped from approximately 250 degrees to 135 degrees in approximately 30 minutes. Removing excess heat from the mixing tank and lowering the temperature of the mushroom substrate included continuously refilling and dumping cold water from the water pipe. The water pipe may be filled from a first water line and/or a secondary water line positioned within the mixing chamber. This fill-and-dump cycle shortened the time to reach a mushroom substrate temperature of 90 degrees from approximately 48 hours to 8 hours. Alternatively, ice cubes could be utilized to cool the mushroom substrate.

After the substrate reached 90 degrees, the bulk inoculation process began. A HEPA fan positioned along a surface of the tank was turned on and the valve in a HEPA filter assembly was opened to permit filtered air to flow into the tank through the valve of the air filter assembly. The HEPA fan above the inoculation port was turned on. UV light was added to reduce contamination. Grain spawn (or, alternatively liquid culture) was added to the mushroom substrate through the inoculation port. The spawn was approximately 3-20% of the substrate by total weight. The spawn was mixed into the mushroom substrate using the ribbon agitator for a minimum of 15 minutes.

After the spawn was fully mixed into the mushroom substrate, all hatches and open valves of the mixer were closed and sealed. The sterilized, inoculated mushroom substrate was sealed into individual bags and placed on racks for colonization, fruiting and harvest.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The disclosure's scope is, of course, defined in the language in which the appended claims are expressed.

1. A single stage mixer for cultivating mushrooms, comprising:
a mixing container defining an internal mixing chamber;
a rotatable agitator coupled to the mixing container;
a water supply member positioned within the internal mixing chamber; and
a heating element attached to the mixing container.

2. The single stage mixer of claim 1, wherein the water supply member includes a vertical water pipe positioned within the internal mixing chamber.

3. The single stage mixer of claim 2, wherein the water pipe includes a first end attached to an inner surface of the mixing container, and a second end which is open to the internal mixing chamber of the mixing container.

4. The single stage mixer of claim 3, wherein the water pipe is configured to permit water to overflow out the second end and into the mixing chamber.

5. The single stage mixer of claim 4, wherein the heating element is positioned within the water pipe.

6. The single stage mixer of claim 5, wherein the agitator includes a ribbon agitator.

7. The single stage mixer of claim 6, wherein the ribbon agitator extends circumferentially around the vertical water pipe.

8. The single stage mixer of claim 7, wherein the heating element is configured to heat water in the water pipe to create a water vapor within the mixing chamber, and wherein the water vapor is configured to increase pressure within the mixing chamber.

9. The single stage mixer of claim 8, wherein the increase in pressure within the mixing chamber can heat a mushroom substrate to a temperature and a pressure sufficient to sterilize the mushroom substrate.

10. The single stage mixer of claim 1, wherein the water supply member includes one or more water supply lines positioned within the internal mixing chamber.

11. The single stage mixer of claim 1, wherein the heating element includes a boiler attached to the mixing container.

12. The single stage mixer of claim 1, wherein the heating element includes a gas burner attached to the mixing container.

13. The single stage mixer of claim 1, wherein the heating element includes both a gas burner and a boiler attached to mixing container.

14. The single stage mixer of claim 13, further comprising a steam delivery tube coupled to both the boiler and the mixing container, and wherein the steam delivery tube is configured to transport steam from the boiler into the mixing container.

15. The single stage mixer of claim 14, wherein the boiler is configured to heat the steam when the lid is in the sealed configuration, and wherein the lid is configured to seal against the mixing container such that the boiler can heat a mushroom substrate to a temperature and a pressure sufficient to sterilize the mushroom substrate.

16. The single stage mixer of claim 1, further comprising an input chute having a first end region and a second end region, the first end region coupled to the mixing container and the second end region including a hatch configured to shift between a closed configuration and an open configuration.

17. The single stage mixer of claim 16, further comprising an air filter operatively coupled to a portion of the input chute.

18. The single stage mixer of claim 1, further comprising a discharge chute assembly, the discharge assembly including an upper discharge chute and a lower discharge chute, and wherein the lower discharge chute is configured to extend from a first length to a second length.

19. A single stage mixer for cultivating mushrooms, comprising:
a mixing container defining an internal mixing chamber;
a manway coupled to the mixing container;
an inoculation port coupled to the mixing container;
a ribbon agitator coupled to the mixing container; and
a water delivery member coupled to the mixing container.

20. A method for cultivating mushrooms, the method comprising:
loading substrate into a single-stage mixer, the mixer comprising:
a mixing container;
a ribbon agitator coupled to the mixing container;
an inoculation port;
a water delivery member in fluid communication with the mixing container;
a discharge chute coupled to the mixing container; and
a heating element coupled to the mixing container;
loading grain spawn into the single-stage mixer through the inoculation port;
turning the ribbon agitator to mix the grain spawn with the substrate;
discharging the substrate into a bag; and
sealing the bag.
